(19) United States
(12) Patent Application Publication
(10) Pub. No.: US 2026/0344881 A1
(43) Pub. Date: Nov. 5, 2026

(54) SYSTEMS AND/OR METHODS FOR SANITIZING BRUSHES

(71) Applicant: MRS YTECH LTD, Kfar Yona (IL)

(72) Inventor: Yardena IFRAH, Kfar Yona (IL)

(21) Appl. No.: 19/482,746

(22) PCT Filed: May 16, 2024
(86) PCT No.: PCT/IB2024/054757

§ 371 Date: Nov. 8, 2025

Related U.S. Application Data
(60) Provisional application No. 63/467,037, filed on May 17, 2023.

(51) Int. Cl. A46B 17/06

(52) U.S. Cl. CPC A46B 17/065

(57) ABSTRACT

A system for sanitizing brushes, e.g. makeup brushes, has a central axis and includes a base, a work tank formed about the central axis, and a drum located above the work tank. The drum includes a brush holder for securing a brush within the system with its bristles adjacent a lower floor of the work tank. And the sanitizing process of the system includes urging rotation at the drum in order to rotate brushes that are secured to the drum.

### TECHNICAL FIELD

Embodiments of the invention relate to systems and/or methods for sanitizing brushes, for example makeup brushes, paintbrushes and the like.

### BACKGROUND

Makeup in cosmetics refers to products that are applied to the face or body—and makeup brushes may be used for enhancing appearance of a person's eyebrows, eyelashes (and the like).

During use, such makeup brushes may accumulate dirt, including bacteria and the like, and therefore it is important to clean the brushes after use in order to maintain hygiene, quality of the brush (etc.).

Sanitizing makeup brushes is important in order to prevent growth and spread of bacteria (and the like) during repeated use.

Cleaning makeup brushes typically includes steps such as rinsing the brushes in a liquid cleanser, which cleans or removes dirt or other substances from the brushes, and then drying the brushes for example using a clean towel, paper towel (or the like).

### SUMMARY

The following embodiments and aspects thereof are described and illustrated in conjunction with systems, tools and methods which are meant to be exemplary and illustrative, not limiting in scope.

In a broad aspect of the present disclosure there is provided a product system and/or method designed to allow any person and/or professional to sanitize one or more makeup brushes.

In the following disclosure, makeup brushes will be presented as an example for demonstrating the various inventive aspect of the present invention, however it is noted that the disclosed systems and/or methods herein can be used for a variety of other types of brushes, such as paintbrushes (and the like).

A sanitization process of a brush in the context of the various embodiments of the present invention may include any one of: cleaning, disinfection and/or drying processes. In certain cases, the disinfection stage may be conducted to a degree that substantial sanitization may be accomplished.

In certain embodiments, the stages of functioning and operation of the method/product/system may include first providing a customer/user as a kit and/or bag and/or packaging a system built and ready for work and use.

The system or product may be based on components such as providing a system with a central base anchor with all operating systems and hardware, including a tank for water/liquids and detergents.

Possibly, also may be provided a biodegradable and/or refillable container for ozone. In certain cases, an ozone motor may be instead or in addition provided built in within the system.

A cap like brush holder drum including brush connectors may be located above the system's tank, with one or more brushes being securely fitted, preferably at their handles, each within a respective brush connector. Each brush securely fitted to the drum may be positioned with its bristles oriented generally downwards within the tank such that they are located adjacent a floor of the tank.

In certain embodiments, a cap like brush holder drum located at the upper side of the tank may be rotatable about a central rotation axis of the system by an electric and/or other motor.

In certain embodiments, in addition to or instead of a revolving drum, the system may be designed such that each brush holder within the drum may be urged to rotate about a distinct auxiliary axis that passes there-through together with the makeup brush that is fitted therein. As a result, each brush fitted to such a drum may be urged to generally revolve about a central longitudinal axis of its handle.

The work tank may be filled with a required amount of water and/or also cleaning/disinfecting materials/substances in order to assist in cleaning of the makeup brushes while they are urged to rotate all together about the system's central axis and/or about the distinct auxiliary axis passing through each brush connector.

Activation of a sanitization process within such systems may be accomplished e.g. by pressing an activation button to activate the device/system thus urging the systems/product to start a cleaning cycle that includes urging the drum and/or each brush connector within the drum to rotate according to a speed or speed profile defined within the system and/or according to a customer's programming/preference.

In various embodiments, the device/system may be arranged to perform a number of different sanitization operations, possibly according to different stages.

A cleaning operation may be based on a number of elements, such as rotational movement of the brushes within the device, friction of the brushes against possible vertical lugs, bristles or barb cleaning members, which in one example are structures projecting upwards from a floor of the tank.

In certain cases, a combination of water, soap and/or ozone for disinfection may be used during the sanitization process.

In certain embodiments, a final step of the sanitization process may include drying the brush(es) in the system, by a circular/rotational movement possibly without any detergent, water and/or others substances within the tank.

In various cases, refilling and/or replacement of ozone may be required after a certain amount of cleaning cycles. This may be not necessarily in certain cases if an ozone motor may be used.

Methods of operation may include provision of new consumable component/tank and/or by ordering a professional service providers.

Further aspects of the present disclosure may be defined in the following:

In at least certain embodiments a product, system and/or method may be provided allowing any person and/or professional to sanitize brush(es), in a professional, efficient, hygienic and fast manner.

Such product, system and/or method may include a method and methodology comprising providing a dedicated and professional device/machine based on washing and drying in rotary motion and friction on vertical cams.

Such product, system and/or method may include using ozone substance and/or combined with water and/or other substances, which are urged to flow through the brushes during rotation and friction-in order to transition brushes after use to a state where they are clean, hygienic and/or sterile and ready for reuse.

In accordance with the various embodiments of the present invention, the product/system may be made from polymer materials and/or metals and/or a combining of such materials.

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows typical makeup brushes of various shapes and sizes;

FIG. 2 schematically shows a perspective upper view of an embodiment of a system in accordance with the present invention for sanitizing such brushes;

FIGS. 3 and 4 schematically show respective upper and side views of the system of FIG. 2;

FIG. 5 schematically shows a perspective lower view of an embodiment of a system in accordance with the present invention for sanitizing brushes;

FIG. 6 schematically shows a cross sectional view of the system of FIG. 5 including in this example a makeup brush fitted to the system and revealing internal components of the system;

FIGS. 7 and 8 schematically show perspective front views of an embodiment of a system for sanitizing brushes, in respective assembled and disassembled states;

FIGS. 9 and 10 schematically show perspective rear views of the system seen in FIGS. 7 and 8, in respective assembled and disassembled states;

FIGS. 11A and 11B schematically show perspective front views of embodiments of a work tank and a drum of the present invention, in respective assembled and disassembled states one from the other, revealing in the disassembled state a coupling member that may be used to couple between the work tank and drum during cleaning and/or disinfecting cycles of a system;

FIGS. 12A and 12B schematically show perspective front views of the work tank and drum seen in FIG. 11, in respective assembled and disassembled states one from the other, revealing in the disassembled state a different coupling member that may be used during a drying cycle of the system to couple between the work tank and drum;

FIGS. 13A and 13B schematically show cross sectional views of the assembled states seen in FIGS. 11A and 12A, respectively;

FIGS. 14A and 14B schematically show perspective lower views of an embodiment of a drum usable within the system embodiments of the present invention, in respective non cross sectional and partially cross sectional views;

FIG. 15 schematically shows a lower view of the drum as seen in FIG. 14B; and

FIGS. 16 and 17 schematically show an embodiment of a mechanism for lifting and lowering a system's drum.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

In the following disclosure, makeup brushes will be presented as an example for demonstrating the various inventive aspect of the present invention, however it is noted that the disclosed systems and/or methods herein can be used for a variety of other types of brushes, such as paintbrushes (and the like).

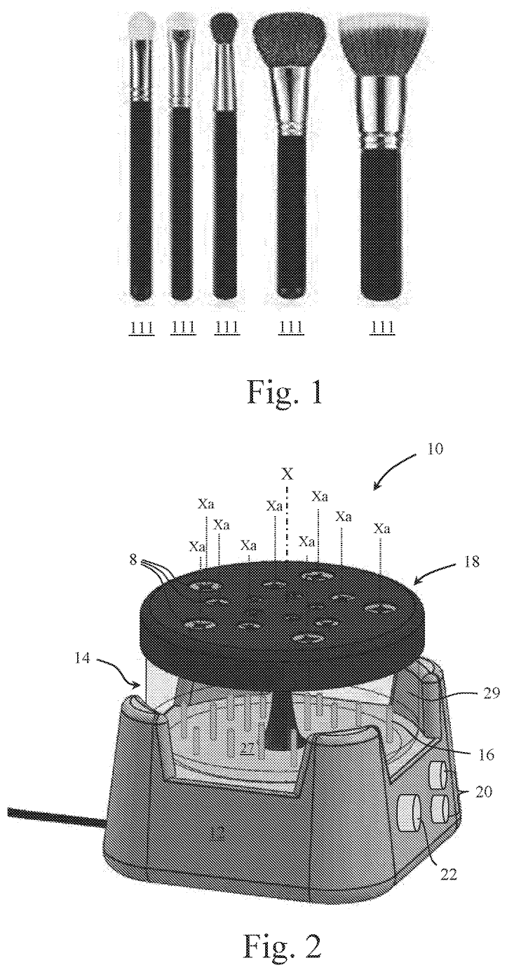

Makeup brushes 111 as exemplified in FIG. 1, which come in various shapes and sizes—may be used for enhancing appearance of a person's eyebrows, eyelashes (and the like). During use, makeup brushes may accumulate dirt, including bacteria and the like, that need to be sanitized before the brushes can be reused.

Attention is drawn to FIG. 2 schematically showing a perspective upper view of an embodiment of a sanitation system 10 in accordance with the present invention for sanitizing brushes, such as the makeup brushes seen in FIG. 1.

It is noted that the term sanitation in the context of the present disclosure may include any one of: cleaning, disinfecting, drying (and the like).

As seen in this example, the system includes a base 12 serving as a central anchor for supporting a work tank 14 having a liquid capacity formed by a lower floor 27 and an outer wall 29 that extends axially upwards from a periphery of the floor. In this example the work tank 14 can be seen being equipped with integrated vertical projecting lugs or barb cleaning members 16, which are suitable for cleaning by friction brushes that are supported within the system and “brush” against the cleaning members 16 with their bristles e.g. during a cleaning cycle of the system. As seen, in this embodiment the cleaning members 16 project upwards from the lower floor 27 of the work tank 14 and may be adapted to have different heights above the floor in order to engage a brush's bristles at different regions.

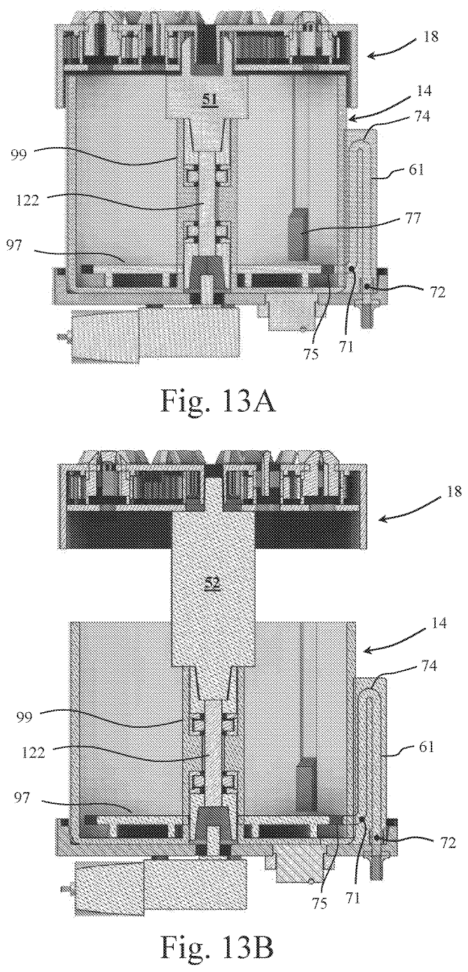

In certain embodiments, the cleaning members 16 may project upwards from a lower plate like element 97 (see e.g. FIGS. 13A and 13B), and hence together with the plate like element may form a district separate member that can be inserted into the work tank to be located on the tank's floor.

The system further includes a housing drum 18, which in this example is formed as a cap like member that generally covers or overlies an upper open side of the work tank 14.

The drum in addition may be configured to include a plurality of brush connectors 8 that are suitably formed therein for securing brushes within the system during a sanitizing process.

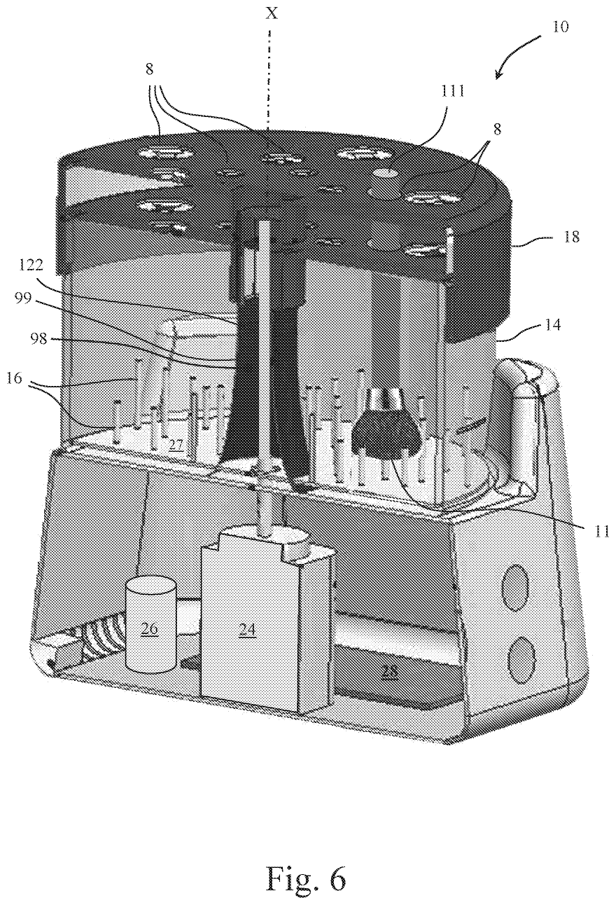

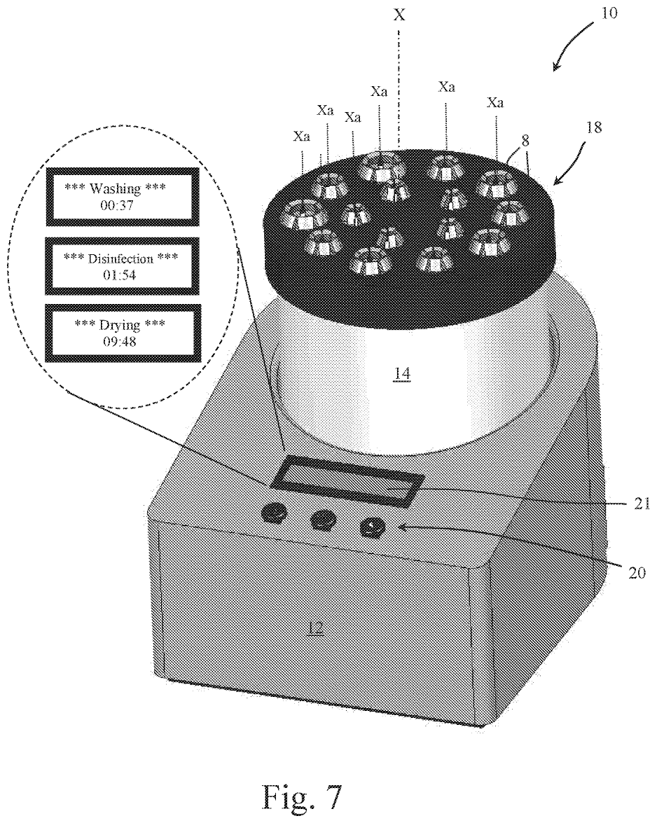

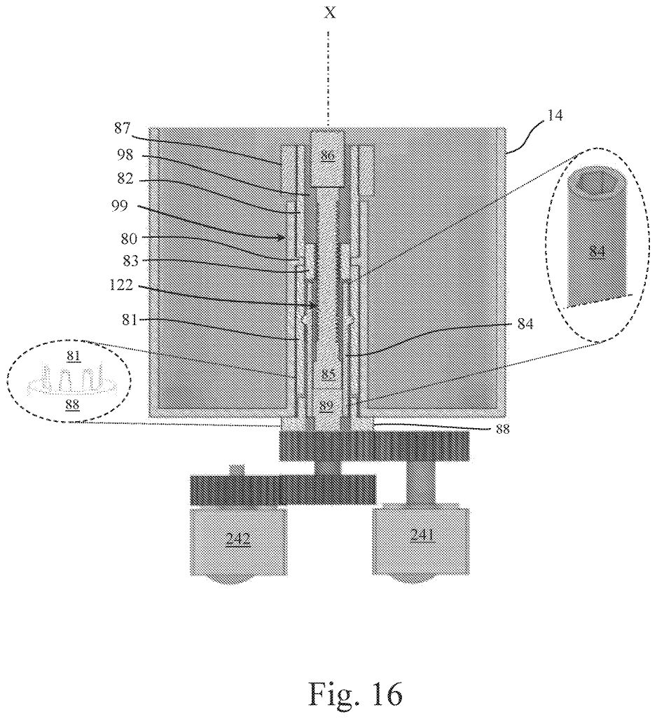

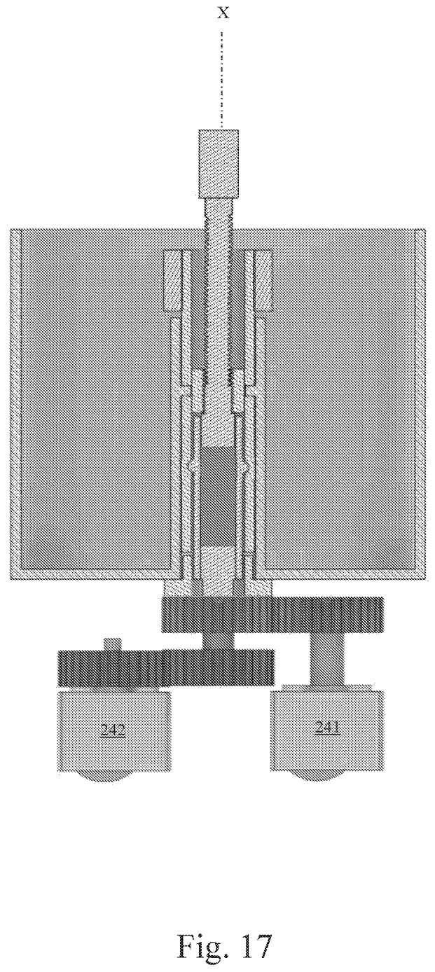

In certain embodiments the drum 18 may be arranged to rotate about a central axis X (see indicated by ‘dashed-dotted’ line) of the system via a motor (see e.g. motor 24 seen in FIG. 6 or 241 seen in FIGS. 16 and 17) that may be housed within the base.

In certain embodiments, in addition or instead of a revolving drum about axis X, the system may be arranged at least during the cleaning and disinfecting stages such that each brush holder 8 within the drum may be urged to rotate about a respective distinct auxiliary axis Xa (see indicated by ‘dotted’ lines) that passes there-through. Such rotation about distinct auxiliary axes Xa may be accomplished by the same motor urging rotation about the central axis X or via a different motor as seen e.g. in FIGS. 16 and 17.

As a result, each brush fitted to such a brush holder may be urged to generally revolve about a longitudinal axis along which the handle of its brush generally extends.

The system in FIG. 2 can also be seen including control and/or operation buttons or toggles 20 for controlling/activating sanitization operations of the system. Here the toggles 20 are seen fitted to the base 12.

Also seen formed on the system's base is an optional disinfectant cartridge inlet 22 for receiving disinfectant substances such as ozone or the like, which may be used in the system as part of the sanitization process. A cartridge connectable to the inlet may be biodegradable or refillable.

In certain embodiments, instead or in addition to receiving disinfectant substances from a cartridge (or the like), the system may include a disinfectant motor, such as an ozone motor, for generating and producing the disinfectant substances.

Such disinfectants may be used to disinfect and purify liquid and/or bristles of brushes located within the work tank 14 by eliminating or substantially reducing bacteria, viruses, and other microorganisms effectively without leaving harmful residues.

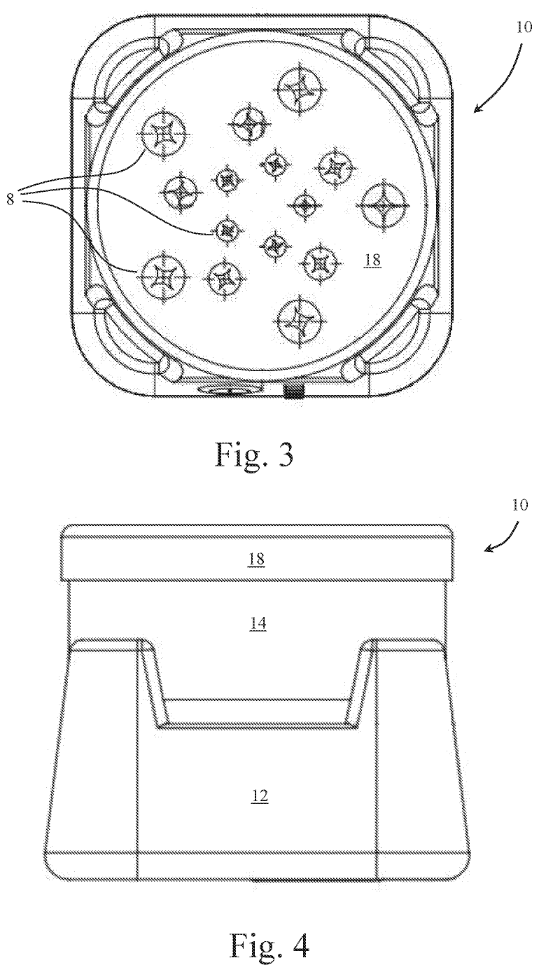

With attention additionally drawn to FIG. 3 to 6 further possible elements of systems in accordance with the various embodiments of the invention may be seen.

In FIG. 6 for example a possible disposable or refillable chamber 26 for ozone can be seen schematically illustrated. Also seen in this cross sectional view are hardware and control components 28 of the system that may be placed within the system's base. As aforementioned, instead of use of a disposable or refillable chamber, element 26 indicated in FIG. 6 may schematically represent a disinfectant motor, such as an ozone motor.

A sanitization method for brushes in accordance with an embodiment of the present invention may include a first stage of cleaning the makeup brushes, a second stage of disinfecting the makeup bushes and a third stage of drying the brushes.

The cleaning process may include initially placing one or more brushes 111 within the system with their bristles 11 located adjacent the lower floor 27 of the work tank.

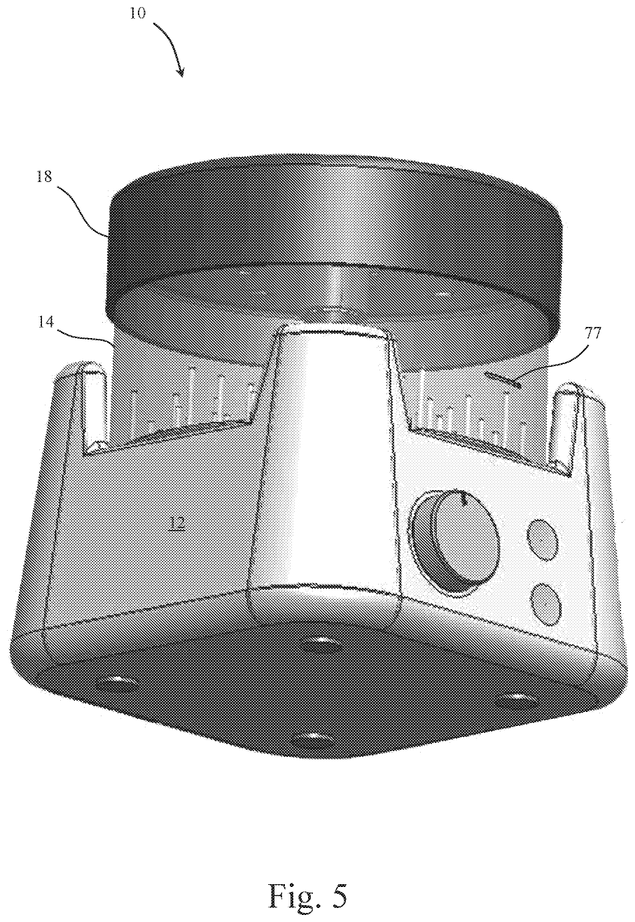

Possibly, an alcohol based disinfectant may be used within a liquid that is placed in the work tank 14 as part of the cleaning/disinfection process applied to the brushes. Possibly, a visible marking 77 (see, e.g., FIG. 5) located upon the work tank may be used to indicate the amount of liquid that is required for the cleaning/disinfection process.

In certain cases, the marking may be formed as a floatable member (see 77 e.g. FIG. 13A), which is movable along an upright slit along an inner side of the work tank's side wall—in order to indicate the amount of liquid entered into the work tank. Forming the work tank from transparent material may enable viewing such a floatable visible marking 77 from outside of the work tank.

In one example, the optional alcohol based disinfectant added to the liquid within the work tank may include organic compounds, possibly colorless organic compounds. In one example, the chosen alcohol based disinfectant may be configured to evaporate relatively quickly. Examples of such alcohol based disinfectants may include Isopropyl alcohol (IUPAC name propan-2-ol).

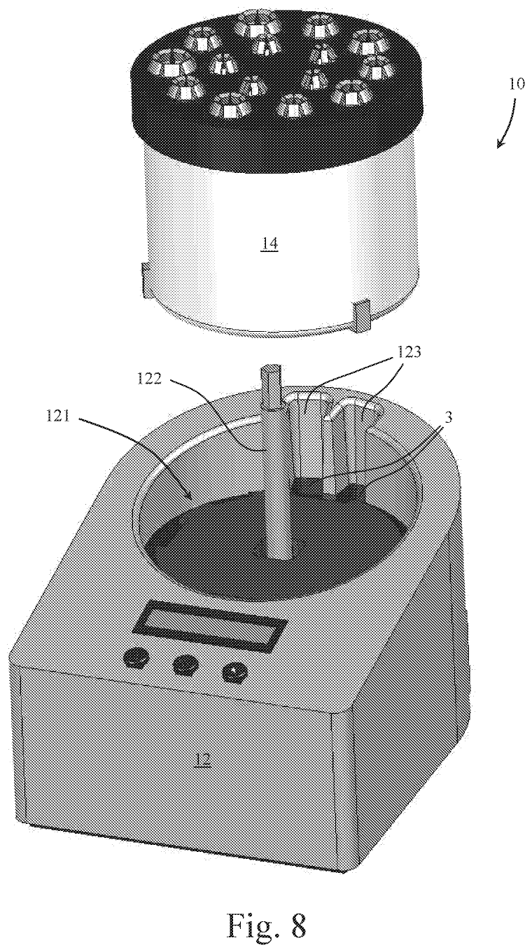

Attention is drawn to FIGS. 7 and 8 schematically showing perspective front views of an embodiment of a system for sanitizing brushes, in respective assembled and disassembled views.

As seen in FIG. 8, the base 12 of the system includes in this example a generally cylindrical cavity 121 and a rod 122 that extends upwards from a center of the cavity. The rod 122 may be coupled to one or more electrical motor(s) (not seen in this view) possibly located within the base beneath the cavity and the rod can be rotatable by such motor(s).

The work tank 14 (as also in other embodiments) can be detachable from the base 12 and can be assembled to the base to reach e.g. the state seen in FIG. 7. Assembling the work tank 14 to the base 12 may include locating the rod 122 within a central passage formed within a peripheral wall that extends up form a floor of the work tank (see e.g. 98 for central passage and 99 for peripheral wall being indicated in FIGS. 6, 11B, 12B and 16). The central passage 98 opens out of the work tank in a downward direction via a lower face of the work tank. The drum 18 when attached to the upper side of the work tank may be adapted to engage with the upper end of the rod 122.

As seen in FIG. 8, the cavity 121 includes at its rear side in this example a pair of grooves 123 that extend each upwards while opening sideways into the cavity. Each groove at its lower end communicates via a respective aperture 3 with a fluid channel formed within the base. It is noted that one or more than two such grooves 123 may exist in various embodiments.

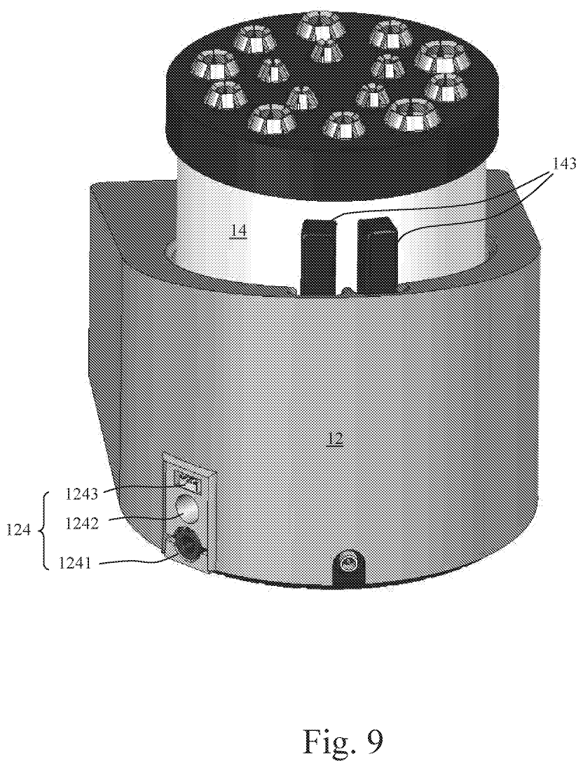

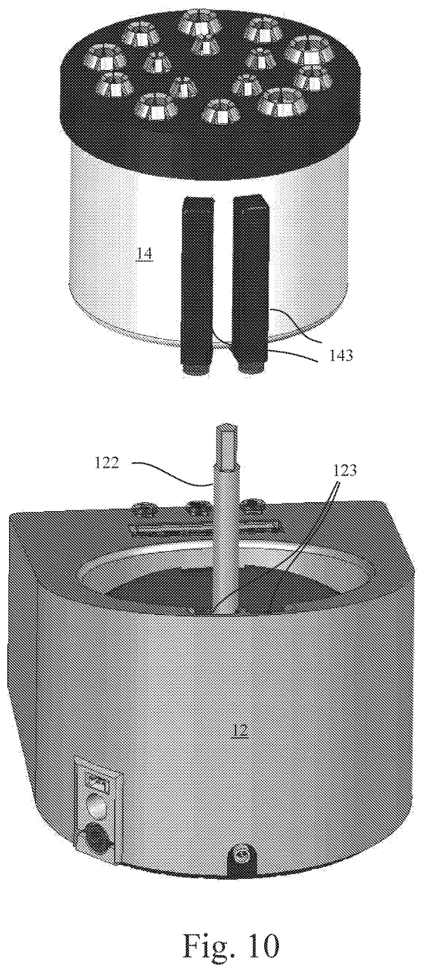

Attention is additionally drawn to FIGS. 9 and 10 schematically showing perspective rear views of the system seen in FIGS. 7 and 8, in respective assembled and disassembled states.

The work tank 14 as seen includes at its rear side in this example a pair of upward extending tank-ports 143 that are arranged each to fit into a respective groove 123 when the work tank is assembled to the base. It is noted that the number of tank-ports 143 may be one or more than two, and in some cases may be configured to correspond to the number of grooves 142 (but not necessarily).

A conduit (see 61 in FIG. 13) extending through each tank-port 143 may be arranged to communicate at its inner end (see 71 in FIG. 13) with the interior of the work tank and when assembled to the base may be arranged to communicate at its other opposing outer end (see 72 in FIG. 13) via an aperture 3 with a fluid channel within the base.

As seen in FIG. 13, the conduit 61 extends curving through its tank-port upwards from its outer end 72 to an apex 74 and then turns downwards to extend towards its inner end 71. The curving path of the conduit 61 that extends up and down from an apex 74 assists in limiting spillage of liquids out of the work tank as it is detached from the base, which may otherwise occur if the outlet path for liquid from the work tank/tank-port would be devoid of such an apex mid-way, e.g. generally sideways from generally around inner end 71.

Also seen in FIG. 13 is an optional liquid level sensor 75 for detecting presence of liquid within the work tank, here being located adjacent to where inner end 71 communicates with the interior of the work tank. Such a sensor 75 may assist in ensuring that liquid is present within the work tank prior to starting a disinfection stage of the system. Since disinfectant substances, such as ozone, are more soluble in liquid than in air, in certain embodiments a step of confirming that liquid is present within the work tank may assist in ensuring that the disinfection stage of brushes secured within the system may be more effective.

Fluid communication provided via the conduits in the tank-ports between the interior of the work tank 14 and the base 12—are arranged to provide routes for liquids and/or gaseous that are used during the cleaning, disinfection and possibly drying stages of the sanitization process.

As seen in FIG. 9, a base-port 124 may be provided at a rear side of the base to facilitate e.g. emptying of the work tank via the conduits in the tank-ports and the fluid channels within the base via a liquid port 1241. A gas port 1242 may be provided for evacuating gaseous (e.g. air) out of the work tank and/or for communicating gaseous (e.g. air, possibly heated air) towards the work tank e.g. during a drying cycle of the system. An electrical connector 1243 may be present for providing electrical communication to external electrical components, such as faucets/pumps for evacuating liquids out of the work tank and/or for communicating liquids towards the work tank. Such electrical components in certain embodiments may be integrally formed within the system, e.g. within the system's base.

For example, when a cleaning stage and possibly a disinfection stage of the sanitization process ends, the cleaning liquid or liquids/substances used during disinfection may be emptied via the liquid port 1241 prior to the start of a drying stage or cycle of the sanitization process.

Attention is drawn back to FIG. 7 showing also a display 21 that may be provided within the system for displaying the various stages/cycles and progress of the sanitization process. In this example, the display is provided at the base adjacent the toggles 20 that control the sanitization process.

As seen in the enlarged section (encircled by the ‘dashed’ ellipse) at the left-hand side of the figure, display 21 can be seen indicating various stages of operation of the system, such as: (from top to bottom) the “washing”, “disinfection” and “drying” stages/cycles—and in this example the duration of time that each stage/cycle has until completion.

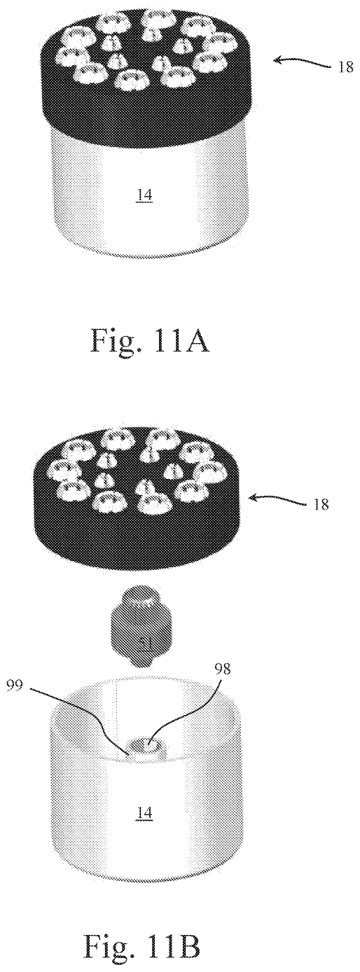

Attention is drawn to FIGS. 11A and 11B schematically showing embodiments of a work tank 14 and a drum 18 of the present invention, in respective assembled and disassembled states one from the other.

In the disassembled state seen in FIG. 11B, a coupling member 51 can be seen being used for coupling between the work tank 14 and the drum 18 during cleaning and/or disinfecting cycles of a system.

In the assembled state of FIG. 11A, a rod (see 122 e.g. in FIGS. 8 and 10) located within the passage 98 formed in the work tank, may be arranged to engage the lower side of the coupling member 51, while the upper side of the coupling member 51 may be arranged to engage the drum 18 from beneath.

As a result, a rotational motion applied via the rod 122 may be transmitted via the coupling member 51 towards the drum 18—in order to urge rotational motions at the drum for rotating brushes fitted to the drum about axis X and/or about each auxiliary axis Xa.

As seen in FIGS. 11A and 11B, during the cleaning and/or disinfecting cycles, a system equipped with such work tank 14, drum 18 and coupling member 51—may be coupled such that the drum 18 encloses the upper opening of the work tank 14 to stop or limit spillage of liquids out of the work tank as the cleaning and/or disinfecting cycles occur.

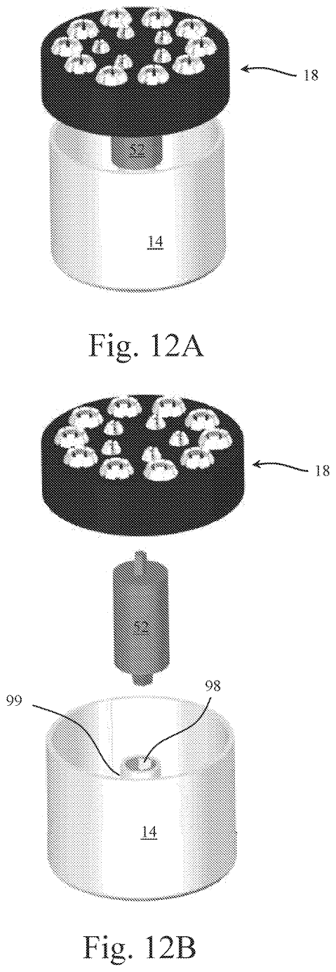

Attention is drawn to FIGS. 12A and 12B schematically showing embodiments of a work tank 14 and a drum 18 of the present invention, in respective assembled and disassembled states one from the other.

In the disassembled state seen in FIG. 12B, a coupling member 52 can be seen being used for coupling between the work tank 14 and the drum 18 during cleaning and/or disinfecting cycles of a system.

In the assembled state of FIG. 12A, a rod (see 122 e.g. in FIGS. 8 and 10) placed through the passage 98 formed in the work tank, may be arranged to engage the lower side of the coupling member 52, while the upper side of the coupling member 52 may be arranged to engage the drum 18 from beneath.

As a result, a rotational motion applied via the rod 122 may be transmitted via the coupling member 52 towards the drum 18—in order to urge rotational motions at the drum for rotating brushes fitted to the drum about axis X and/or about each auxiliary axis Xa.

As seen in FIGS. 12A and 12B, during a drying cycle, a system equipped with such work tank 14, drum 18 and coupling member 52-may be coupled such that the drum 18 is lifted via the coupling member 52 above the upper opening of the work tank 14 in order to allow air from the ambient environment be enter the work tank to assist in the drying cycle of the brushes that are fitted to the drum.

It is noted that the work tank 14 and drum 18 seen in FIGS. 11 and 12 may be generally similar, while use of the different type of coupling member 51 or 52 in this example may transition the generally same work tank and drum between a configuration suited for cleaning and/or disinfecting cycles and a configuration suited for a drying cycle.

In FIGS. 13A and 13B these two different configurations can be seen in the cross sectional views that are provided.

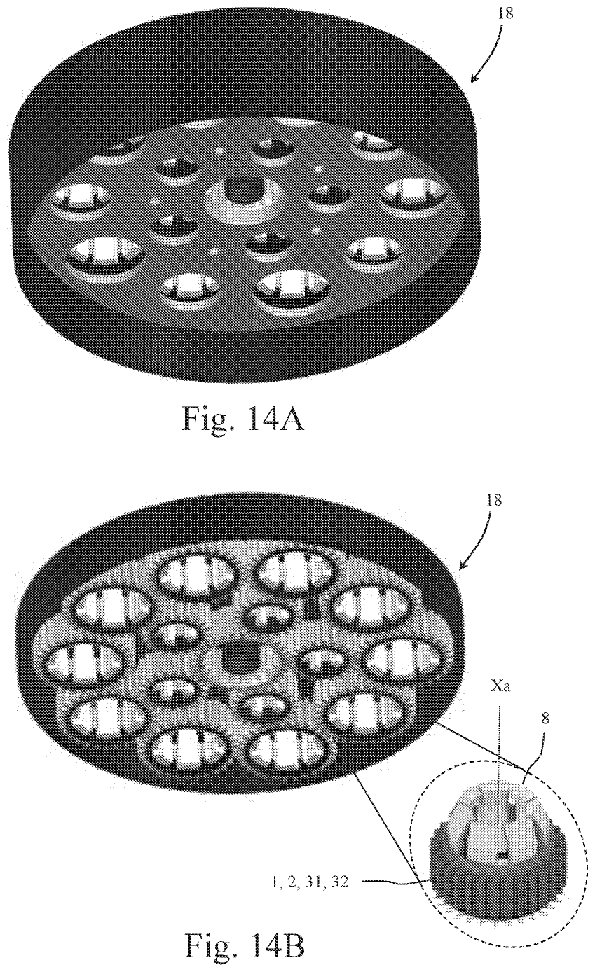

Attention is drawn to FIGS. 14A and 14B schematically showing perspective lower views of an embodiment of a drum 18 usable within the system embodiments of the present invention. The cross sectional view of FIG. 14B reveals optional interior mechanisms of the drum used for urging rotational motions within or at the drum.

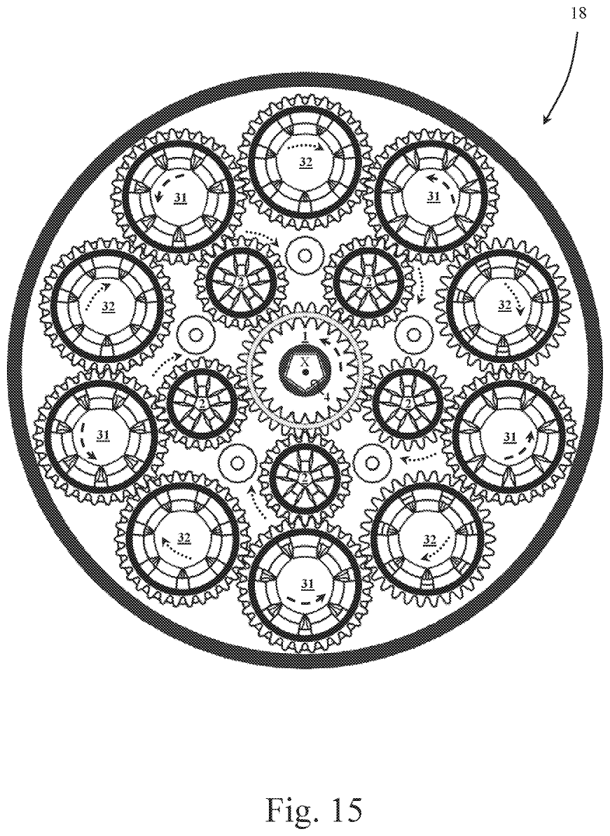

With attention drawn to FIG. 15 for a closer view of the interior mechanisms of the drum 18 can be seen.

As seen, this mechanism includes a series of cog wheels, including primary cog wheel 1 formed about a central axis of the drum that is adapted to coincide with a central axis X of the a sanitation system to which the dram is attached.

A series of secondary cog wheels 2 are placed about the primary cog wheel 1. Each secondary cog wheel 2 is arranged to engage the primary cog wheel 1 at its inner radial side.

A peripheral cog wheel 31 is placed radially outwards relative to each secondary cog wheel 2 in a position where it is engaged with its respective secondary cog wheel 2 at its inner radial side.

And an intermediate cog wheel 32 is placed in between each pair of adjacent peripheral cog wheel 31 to be engaged with said pair.

As seen in the enlarged section at the lower right-hand side of FIG. 14B, each primary 1, secondary 2, peripheral 31 and intermediate 32 cog wheel is associated with a brush holder 8 of the drum 18, and defines an auxiliary axis Xa (generally parallel to central axis X) about which it's associated brush holder 8 can revolve.

As seen, rotation of the primary cog wheel 1 is adapted to urge rotational motions of the secondary 2, peripheral 31 and intermediate 31 cog wheels, while adjacent cog wheels that mesh and engage as seen are adapted to rotate in opposing rotational motions.

This is illustrated by the ‘dashed’ arrows that indicates rotation in a first rotational direction and the ‘dotted’ arrows that indicate rotation in a second opposing rotational direction.

A coupling member, such as 51, that is used in a sanitation system 10 can be fitted to mesh with the primary cog wheel 1 at its upper side in order to urge rotational motion, inter alia, of each brush holder 8 of the drum about its respective auxiliary axis Xa during a cleaning/disinfection cycle.

A socket 4 as seen can be formed within the drum 18 at a location that is accessible via an opening formed through the primary cog wheel 1. A coupling member, such as 52, that is used in a sanitation system 10 can be fitted to engage at its upper side with the socket 4 in order to urge rotational motion, inter alia, of the drum 18 while lifting the drum 18 above the work tank 14 during a drying cycle in order to enable air from the ambient environment to enter the work tank and assist in the drying cycle. It is noted that during a drying cycle, the work tank may be substantially empty of liquids therein.

Attention is drawn to FIGS. 16 and 17 demonstrating an optional mechanism for automatic lifting and lowering of the system's drum 18 to facilitate automatic controlled transition between a cleaning/disinfecting cycle and a drying cycle. This mechanism as seen generally extends along the system's axis X when the work tank s fitted to the system's base.

The tank's peripheral wall 99 enclosing passage 98 includes in this example an inward projecting peripheral ledge 80 and the mechanism here can be seen including a lower sleeve 81 and an upper sleeve 82 placed, respectively, below and above the ledge.

An insert 83 having an internal thread may be located internally to the ledge 80 while slightly overlapping the lower and upper sleeves 81, 82. The lower and upper sleeves 81, 82 and the insert 83 are fixed, e.g. glued, to each other where they overlap, while being free to rotate within the peripheral wall 99. As a result, the lower and upper sleeves 81, 82 together with the insert 83 form a so-called bearing rotatable within the tank's peripheral wall 99. A gear member 87 having external teeth may be located at an upper side of the upper sleeve 82.

A drive insert 84 located internally to the lower sleeve 81, as seen in the enlarged section at the right-hand side of FIG. 16 may be configured to include an internal socket shape (in this example a hexagonal socket), which is designed to fit over a bolt 85 (in this example a hexagonal bolt) that is located at a lower side of the rod 122 that extends through the drive insert 84.

The rod 122 is located within passage 98 and includes a bushing 86 at its upper side. The rod 122 along its extension between its bushing 86 and bolt 85 includes an external thread.

As seen in the enlarged section at the lower left-hand side of FIG. 16, lower sleeve 81 is arranged to engage via teeth at its lower side with corresponding teeth of an interface 88 that is powered to rotate about axis X via a first motor 241. Drive insert 84 as seen in FIG. 16 is also designed to fit at its lower side over a bolt 89 that is powered to rotate about axis X via a second motor 242.

The automatic transition from a cleaning/disinfecting cycle where the drum is placed just above the work tank to a drying cycle where the drum is lifted above the upper side of the work tank; will be explained through the transition from FIG. 16 to 17, while noting that in both these FIGS. (16 and 17) the drum is absent.

A first action of activating the cog wheels of the drum to rotate each about its respective auxiliary axis Xa during a cleaning/disinfecting cycle may be accomplished by first placing gear 87 within the primary cog wheel 1 of the drum. This is the state seen in FIG. 16.

Controlling both the first and second motors 241, 242 to rotate at a suitably controlled rotational motions in the same rotational direction will urge the brush holders 8 of the drum to rotate about their respective auxiliary axes Xa.

The lower sleeve 81 rotating via the first motor 241, through interaction between the engaging teeth of interface 88 and the lower sleeve 81, will in turn urge the upper sleeve 82 via insert 83 to rotate and transfer this rotational motion via gear 87 to primary cog wheel 1.

By rotating the second motor 242 in a suitably controlled rotational motion in the same rotational direction as the first motor, bolt 89 will urge to rotate and transfer this rotational motion via drive insert 84 to the rod's bolt 85. This will in turn urge rod 122 to rotate, however since insert 83 is rotated in the same direction as rod 122 and in substantially the same rotational speed-the rod 122 will maintain its position along the system's axis X as seen in FIG. 16.

Once the cleaning/disinfecting cycle ends, a transition towards a drying cycle in this mechanism may automatically be controlled by stopping the rotation of the first motor 241, which in turn will stop the rotation of insert 83.

By maintaining rotation of the second motor 242, the rotating rod 122 via its threading engagement with the now static insert 83, will lift upwards and engage via its socket shaped bushing 86 with socket 4 of the drum. Continuing to rotate the rod 122 will then lift the drum above the upper side of the work tank towards the state suitable for the drying cycle.

When the rod's bolt 85 engages insert 83 and continues to rotate it may urge via friction insert 83 and the sleeves 82 and 83 that are fixed thereto to also rotate, and e.g. by configuring first motor 241 to be of a non-latch type (that does not have a mechanism to hold its position when power is removed) this rotation of the drum may be controlled to rotate for the duration of time that the drying cycle is designed to be activated.

In an aspect of the present disclosure, systems of the present invention may be controlled to perform any sequence of sanitization cycles. For example: cleaning and then disinfecting and then drying; or cleaning and then drying; or disinfecting and then drying; or only drying, or only cleaning (etc.).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. A system for sanitizing brushes, e.g. makeup brushes, and having a central axis and comprising in its assembled operative state suitable for sanitizing:
a base, a work tank formed about the central axis and located axially above the base, and a drum located axially above the work tank,
the drum comprising one or more a brush holders suited each to secure a brush within the system such that its bristles are located within the work tank, wherein
a sanitizing process of the system comprises urging rotation at the drum in order to rotate brushes that are secured to the drum.

2. The system of claim 1, wherein urging rotation at the drum comprises rotating the drum about the central axis of the system.

3. The system of claim 1 or 2, wherein urging rotation at the drum comprises rotating each brush holder about an auxiliary axis that is associated with the brush holder and which extends through the brush holder.

4. The system of claim 3, wherein each auxiliary axis is generally parallel to the system's central axis.

5. The system of claim 1, wherein the work tank comprises an upper opening.

6. The system of claim 5, wherein the sanitizing process comprises a cleaning cycle and a drying cycle.

7. The system of claim 6, wherein during the cleaning cycle the drum is closely adjacent or substantially abuts the upper opening of the work tank in order to substantially enclose the upper opening from above.

8. The system of claim 7, wherein during the cleaning cycle liquid cleanser is located within the work tank.

9. The system of claim 6, wherein during the drying cycle the drum is spaced apart from the upper opening of the work tank.

10. The system of claim 9, wherein during the drying cycle the work tank is substantially empty of liquid.

11. The system of claim 6, wherein the sanitizing process comprises also a disinfecting cycle.

12. The system of claim 11, wherein the disinfecting cycle comprises urging disinfectant substances into the work tank.

13. The system of claim 12, wherein during the disinfecting cycle liquid is present in the work tank.

14. The system of claim 12 or 13, wherein the disinfectant substances comprise ozone.

15. The system of claim 14 and comprising an ozone motor for providing ozone for the disinfecting cycle.

16. The system of claim 15, wherein the ozone motor is located in the system's base.

17. The system of claim 1 and comprising cleaning members that project upwards from the floor of the work tank.

18. The system of claim 17, wherein the cleaning members are in form of any one of: vertical projecting lugs or barbs.

19. The system of claim 1 and comprising fluid channels for communicating liquids and/or gaseous towards and/or away from the work tank during the sanitizing process.

20. The system of claim 19, wherein at least a portion of the fluid channels extend through the base.

21. A method for sanitizing brushes, e.g. makeup brushes, and comprising the steps of:
providing a system having a central axis and comprising a base, a work tank and a drum, wherein the drum comprises one or more a brush holders,
securing at least one brush to a brush holder of the drum,
placing the work tank axially upon the base and placing the drum axially above the work tank with the bristles of the at least one bush being located within the work tank, and
activating a sanitizing process of the system that comprises urging rotation at the drum in order to rotate brushes that are secured to the drum.

22. The method of claim 21, wherein urging rotation at the drum comprises rotating the drum about the central axis of the system.

23. The method of claim 21 or 22, wherein urging rotation at the drum comprises rotating each brush holder about an auxiliary axis that is associated with the brush holder and which extends through the brush holder.

24. The method of claim 23, wherein each auxiliary axis is generally parallel to the system's central axis.

25. The method of claim 21, wherein the work tank comprises an upper opening.

26. The method of claim 25, wherein the sanitizing process comprises a cleaning cycle and a drying cycle.

27. The method of claim 26, wherein during the cleaning cycle the drum is closely adjacent or substantially abuts the upper opening of the work tank in order to substantially enclose the upper opening from above.

28. The method of claim 26, wherein during the drying cycle the drum is spaced apart from the upper opening of the work tank.

29. The method of claim 26, wherein the sanitizing process comprises also a disinfecting cycle.

30. The method of claim 29, wherein the disinfecting cycle comprises urging disinfectant substances into the work tank.

31. The method of claim 30, wherein the disinfectant substances comprise ozone.

32. The method of claim 31 and comprising an ozone motor for providing ozone for the disinfecting cycle.

33. The method of claim 32, wherein the ozone motor is located in the system's base.

34. The method of claim 21 and comprising cleaning members that project upwards from the floor of the work tank.

35. The method of claim 34, wherein the cleaning members are in form of any one of: vertical projecting lugs, bristles or barbs.

36. The method of claim 21 and comprising fluid channels for communicating liquids and/or gaseous towards and/or away from the work tank during the sanitizing process.

37. The method of claim 36, wherein at least a portion of the fluid channels extend through the base.

38. A work tank for a sanitization system for brushes, e.g. makeup brushes, and comprising:
a lower floor and an outer wall that extends axially upwards from a periphery of the floor to an upper opening,
the work tank comprises in addition at least one axially extending tank-port formed on an outer side of the outer wall that comprises an internal conduit,
the internal conduit extending from an inner end thereof axially upwards to an apex and then downwards towards an outer end thereof, wherein
the inner end communicates with the interior of the work tank and the outer end is adapted to communicate with flow channels of the sanitization system.

39. The work tank of claim 38, wherein the outer end is axially lower than the inner end.

40. The work tank of claim 38 or 39, wherein the inner end communicates with the interior of the work tank adjacent the floor.

41. The work tank of claim 40 and comprising a liquid level sensor located within the work tank, possibly adjacent to where inner end communicates with the interior of the work tank.

42. A method for sanitizing brushes, e.g. makeup brushes, and comprising the steps of:
providing a system having a central axis and comprising a base, a work tank and a drum, wherein the drum comprises one or more brush holders,
securing at least one brush to a brush holder of the drum,
placing the work tank on the base and placing the drum axially above the work tank with the bristles of the at least one bush being located within the work tank, and
activating a sanitizing process of the system that comprises a cleaning cycle where the drum is generally adjacent to an upper opening of the work tank and a drying cycle where the drum is lifted above the upper opening of the work tank.

43. The method of claim 42, wherein the sanitizing process comprises urging rotation at the drum in order to rotate brushes that are secured to the drum.

44. The method of claim 42 or 43, wherein transition from the cleaning cycle to the drying cycle is manually operated.

45. The method of claim 42 or 43, wherein transition from the cleaning cycle to the drying cycle is automatically controlled.
